(19) United States
(12) Patent Application Publication
(10) Pub. No.: US 2010/0097308 A1
(43) Pub. Date: Apr. 22, 2010

(54) LIQUID CRYSTAL DISPLAY DEVICE AND METHOD FOR DRIVING A LIQUID CRYSTAL DISPLAY DEVICE

(75) Inventor: Petrus M. De Greef, Waalre (NL)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP, B.V., Eindhoven (NL)

(21) Appl. No.: 12/518,413

(22) PCT Filed: Dec. 10, 2007
(86) PCT No.: PCT/IB07/54987

§ 371 Date: Jun. 9, 2009

(30) Foreign Application Priority Data
Dec. 11, 2006 (EP) 06125803.4

(51) Int. Cl. G09G 3/36; G02F 1/13357

(52) U.S. Cl. 345/102; 349/68

(57) ABSTRACT

A liquid crystal display device is provided, comprising a liquid crystal display panel (LCDP) for displaying an image or a video signal. The display device furthermore comprises a double-pulse scanning backlight means (BL) having a plurality of red, green and blue colored light emitting diodes (RLED, GLED, BLED) arranged in rows for backlighting the liquid crystal display panel (LCDP) on a double-pulse scanning basis. Furthermore, a double-pulse scanning control means (CM) is provided for controlling the time sequential double-pulse scanning of the plurality of colored light emitting diodes (RLED, GLED, BLED) of the backlight means (BL) and for driving the time sequential double-pulse scanning of the plurality of colored light emitting diodes (RLED, GLED, BLED).

### FIELD OF THE INVENTION

The present invention relates to a liquid crystal display device and a method for driving a liquid crystal display device.

### BACKGROUND OF THE INVENTION

In order to improve the performance of a liquid crystal display (LCD) device, LCD backlights are used in particular to enhance the brightness of the displayed images or video signals. Previously, side-lit backlights have been used but have been recently replaced by direct-lit backlights as direct-lit backlights improve the brightness of larger size LCD and TV devices.

The continuous lit backlights can be replaced by scanning backlights to further improve the picture quality of a LCD device. By means of scanning backlights motion artifacts which result from sample and hold effects of the LCD panel can be reduced. Back-lit LCD backlights may comprise fluorescence lamps like cold cathode fluorescence lamps CCFL or hot cathode fluorescence lamps HCFL. Typically, a number of fluorescence lamps are arranged horizontally, wherein each lamp illuminates the area in front of it. The light of such a lamp may also contribute to the lighting of more distance areas. If all lamps are on at the same time, a uniformly illuminated backlight can be obtained. However, a scanning backlight can be obtained by lighting the fluorescence in a time sequential manner. To enable a scanning backlight, the respective lamps have to be individually controlled, e.g. by means of separate drivers and by means of a brightness control of each of the lamps. To avoid the scattering of the lights emitted by the fluorescence lamps, optical barriers can be provided between the lamps.

FIG. 9 shows a schematic representation of a backlight unit for a LCD display according to the prior art. The backlight comprises seven rows of colored light emitting diodes LED, i.e. red, green and blue LEDs RLED, GLED, BLED are provided in the rows of the backlight. A control means is provided for each of the rows or horizontal stripes of the backlight. The contrast ratio of the backlights may be increased by means of 0 D, 1 D, 2 D dimming and boosting. Preferably, LEDs with saturated colors are used in order to support a wide color gamut. Furthermore, LEDs are mercury free products hence environmental friendly light sources.

The light emitted by the light emitting devices arranged in rows or stripes can be mixed in order to obtain white light with a desired color temperature, e.g. 9000K. In order to achieve this, a driver needs to be provided for each of the colors R, G and B as each of these colors have different current settings and luminance efficiencies.

The advantage of a scanning backlight is that such a scanning backlight can enable a stroboscopic exposure of any moving images on the LCD panel which is back-lit by the scanning backlight thus improving the motion portrayal of the LCD display.

The perceived flicker of bright objects due to the nominal frame rates of 50 or 60 Hz for a scanning backlight, is mainly determined by the actual brightness and size of the bright objects. In order to remove these flicker or artifacts, the scanning frequency of the backlight can be doubled to 100 or 120 Hz, i.e. a scanning backlight based on double-pulses is used to enhance the motion portrayal. Any scanning backlights with a frame rate of 100 or 120 Hz is invisible to the human eye such that an image flicker will not be perceived anymore. However, due to the double-pulse driving of the scanning backlight, double edges may occur on moving objects.

### SUMMARY OF THE INVENTION

It is therefore an object of the invention to provide a LCD display device with a double-pulse scanning backlight and method for driving the LCD display device with an improved motion portrayal and with a reduced flicker.

This object is solved by a liquid crystal display device according to claim 1 and by a method for driving a liquid crystal display device according to claim 6.

Therefore, a liquid crystal display device is provided, comprising a liquid crystal display panel for displaying an image or a video signal. The display device furthermore comprises a double-pulse scanning backlight means having a plurality of red, green and blue colored light emitting diodes arranged in rows for backlighting the liquid crystal display panel on a double-pulse scanning basis. Furthermore, a double-pulse scanning control means is provided for controlling the time sequential double-pulse scanning of the plurality of colored light emitting diodes of the backlight means and for driving the time sequential double-pulse scanning of the plurality of colored light emitting diodes.

According to an aspect of the invention, the control means drives the plurality of colored light emitting diodes with a primary and secondary pulse within a scanning time period. The duty cycles for the red, green and blue light emitting diodes correspond to each other during the primary pulse while the duty cycles of the red, green and blue light emitting diodes may vary from each other during the secondary pulse. Hence, a sharp and bright first exposure of the primary pulse can be achieved, while the secondary pulse can be used for colored blur.

According to a further aspect of the invention, the secondary pulses have a common center such that the colored blur can be symmetrically driven to booth edges of the pulse.

According to still a further aspect of the invention, the duty cycles of the blue emitting light diode within a secondary pulse are longer than the duty cycles for the red or green light emitting diodes during the secondary pulse. The light capacity of the blue light emitting diode is smaller than the light capacity of the red or green light emitting diodes. As the blue color will only have a limited contribution to the luminescence, the light capacity of the blue light emitting diodes can be reduced.

The invention also relates to a method for driving a liquid crystal display device having a liquid crystal display panel and a double-pulse scanning backlight means. The backlight means comprises a plurality of red, green and blue colored light emitting diodes which are arranged in rows and which are used for backlighting the liquid crystal display panel. The time sequential double-pulse scanning of the plurality of colored light emitting diodes of the backlight means is controlled. The time sequential double-pulse scanning of the plurality of colored light emitting diodes is driven.

The invention relates to the idea to individually control the duty cycle of LEDs of a scanning backlight means of a colored light LCD display device. The scanning of the backlight is performed based on a double-pulse scanning enabling a trade-off between an optimal motion portrayal versus an optimal reduction of flicker. Such a trade-off will depend on the luminescence, the sharpness and the motion of any objects to be displayed on the LCD panel. The light capacity of the scanning backlight may be higher as the light capacity of a non-scanning backlight because the amount of light which is required in a short period may be higher. Furthermore, the duty cycles of the blue, green and red color are controlled individually. LEDs with blue color are operated with a longer duty cycle as the contribution of the blue color to the luminance is less than the contribution of the green and red color. Therefore, the light capacity for the blue color can be less than the light capacity of the green color due to the fact that the LEDs for the blue color have a longer duty cycle. The light capacity and duty cycle for the red color may be chosen in between the light capacity of the red color and the light capacity of the green color. Within the double-pulse scanning, the primary light pulse is selected to provide a sharp primary image, when the liquid crystal material is settled to its new position. On the other hand, the secondary pulse is selected to create a blurred secondary image on the LCD panel when the LCD material is in transition.

According to the invention, the colored blur can be symmetrically driven to both edges of a scanning pulse and all colored blur can be shifted to the secondary pulse of the double-pulse scanning in order to enhance the motion portrayal. As the duty-cycle for blue and red LEDs is increased, less blue and red LEDs are required such that the costs of the scanning backlight means for a LCD device is reduced. Furthermore, with the LCD display device according to the invention a flicker free scanning backlight is provided.

The advantages and embodiments of the present application are now described in more detail with respect to the drawings.

### BRIEF DESCRIPTION OF THE DRAWINGS:

FIG. 1 shows a schematic representation of a LCD device according to a first embodiment,

FIG. 2 shows examples of backlight luminescence profiles of a backlight means according to the invention;

FIG. 3 shows a diagram of a single pulse scanning backlight;

FIG. 4 shows a diagram of a double-pulse scanning backlight according to a first embodiment;

FIG. 5 shows a diagram of a double-pulse scanning backlight according to a second embodiment;

FIG. 6 shows a diagram of a double-pulse scanning backlight according to a third embodiment;

FIG. 7 shows a diagram of a double-pulse scanning backlight according to a fourth embodiment;

FIG. 8 shows a diagram of a double-pulse scanning backlight according to a fourth embodiment; and

FIG. 9 shows a diagram of a backlight for a LCD device according to the prior art.

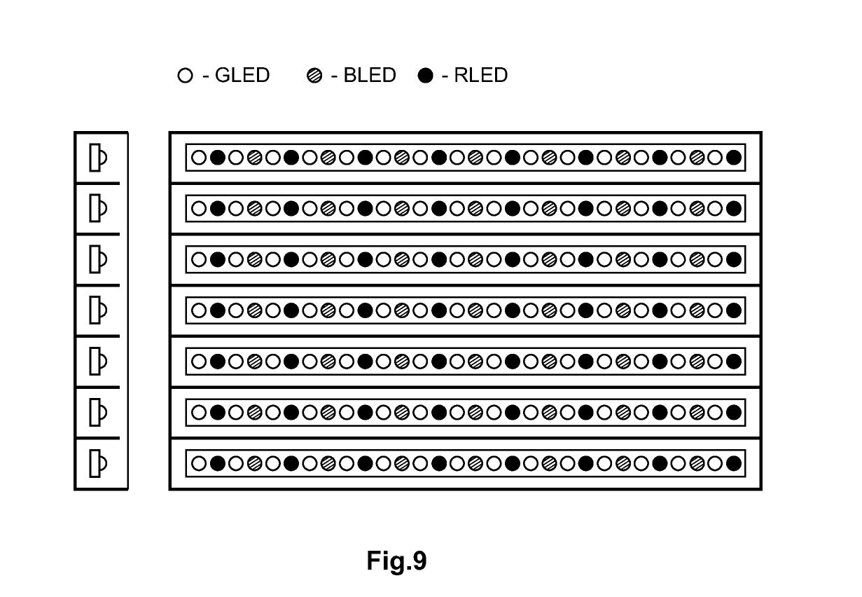

### DESCRIPTION OF EMBODIMENTS

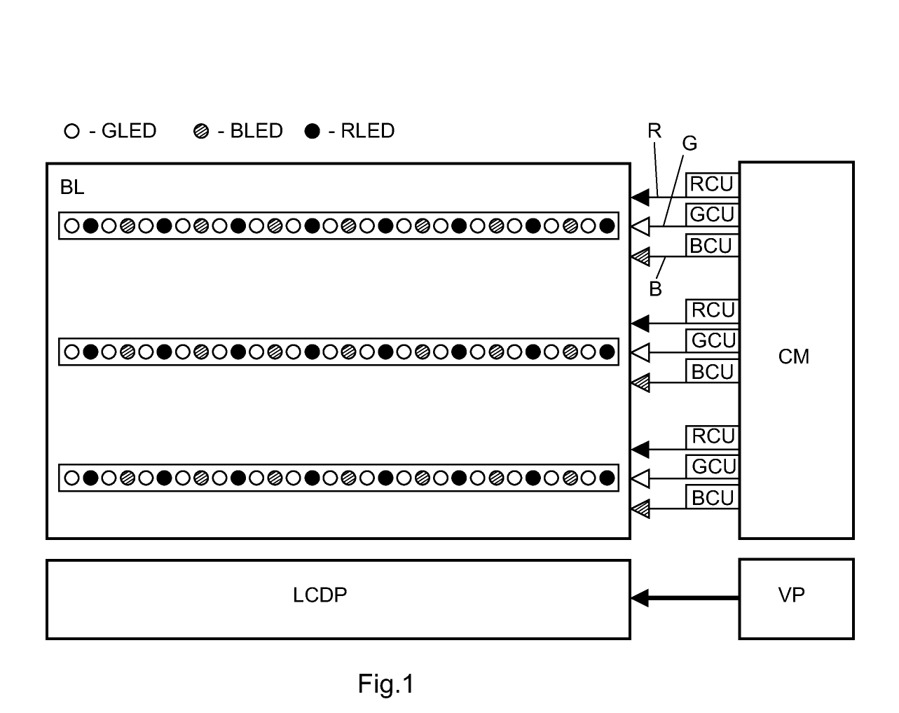

FIG. 1 shows a basic representation of a liquid crystal display device according to a first embodiment of the invention. The liquid crystal display device comprises a LCD display panel LCDP, optionally a video processing unit VP, a backlight means BL and a control means CM for controlling the backlight means BL. The backlight means BL comprises a plurality of colored light-emitting device LED, i.e. green LEDs GLED, red LEDs RLED and blue LEDs BLED. The LEDs are arranged in rows or horizontal stripes. Although in FIG. 1 only three rows of LEDs are depicted, the backlight means BL may comprise more than merely three rows LEDs. Each row of LEDs or each horizontal stripe of LEDs are driven by a control unit for red RCU, a control unit for green GCU and control unit for blue BCU. In other words, the control units RCU, GCU and BCU are associated to each of the rows of LEDs for controlling the colored LEDs in that row. The LCD panel LCDP is used to display the images and video signals from the internal or external video processing unit VP, while the LCD panel LCDP is backlit by the backlit means BL.

The color control units RCU, GCU and BCU for each row of LEDs control the settings of the colored LEDs in the row of LEDs to achieve a global white-point setting. This global white-point setting can be achieved by selecting the luminance ratio of the individual color LEDs RLED, BLED, GLED in a row of LEDs accordingly. By selecting the luminance ratio of the respective rows of LEDs, a global luminance level can be achieved. To achieve a vertical homogeneity the LEDs in the rows of LEDs are addressed individually in order to tune the color as well as the brightness thereof. As the rows of LEDs can be addressed individually by the color control units a scanning backlight can be provided in the same direction as the LCD panel is addressed. In addition, the scanning backlight may be switched on and off. By the control of the color control units, a 1 D segmented double-pulse can be achieved if the LEDs in the rows of LEDs are addressed and driven individually at a higher rate than the corresponding address rate. If a 1 D dimming is required, the duty-cycle of the individual LEDs in the rows of LEDs can be shortened. Furthermore, by driving the LEDs in the rows of LEDs at a high power, a 1 D boosting can be achieved provided that the temperature of the backlight is within a predetermined range. Furthermore, as the LEDs in the rows of LEDs can be individually addressed and driven with respect to their duty cycle as well as their power, the optimal settings for the LEDs can be determined for each frame period.

The modulation of the video data in the video processing unit VP is interpolated from the vertical luminance profiles of the rows of LEDs and the calculated dimming factors of the rows of LEDs, if a 1 D dimming operation is required.

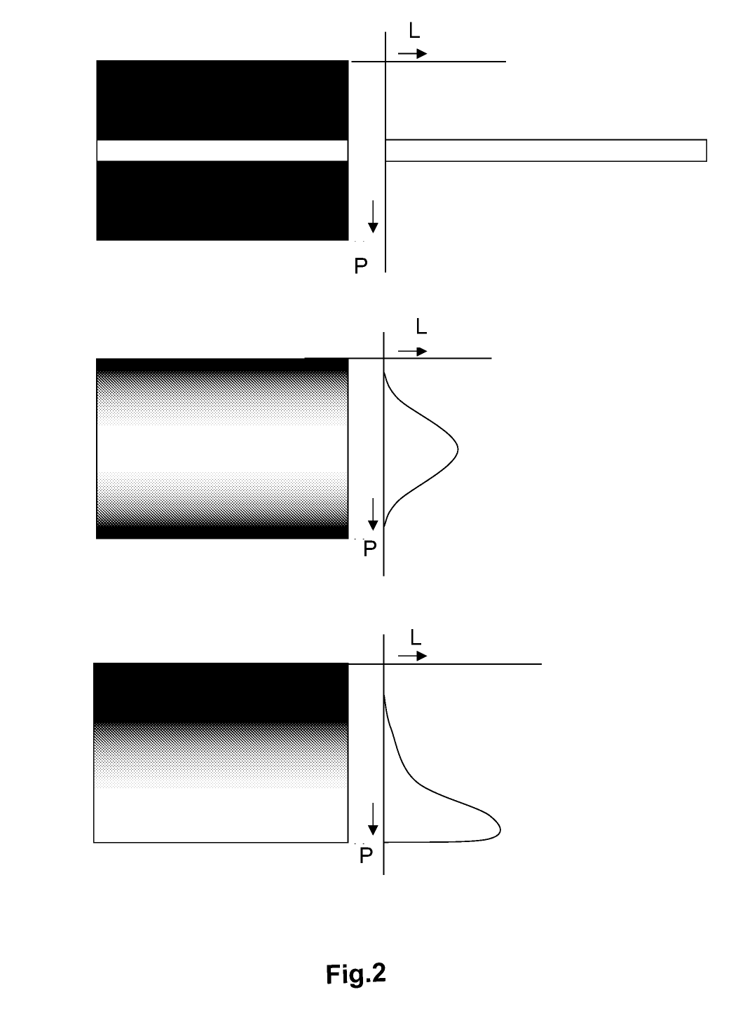

FIG. 2 shows a representation of example of backlight luminescence profiles according to the invention. In FIG. 2, three different backlight luminescence profiles are shown, namely a) a center segmentation for a sharp segmentation, b) a center segmentation on smooth segmentation and c) a bottom segmentation on smooth segmentation. On the left hand side of FIG. 2, the respective segmentations are shown while on the right hand side of FIG. 2 a diagram of the luminescence profile with respect to position is depicted. In other words, by adapting the center segmentation or the bottom segmentation, the desired segmentation being it smooth or sharp of the luminescence profile can be achieved.

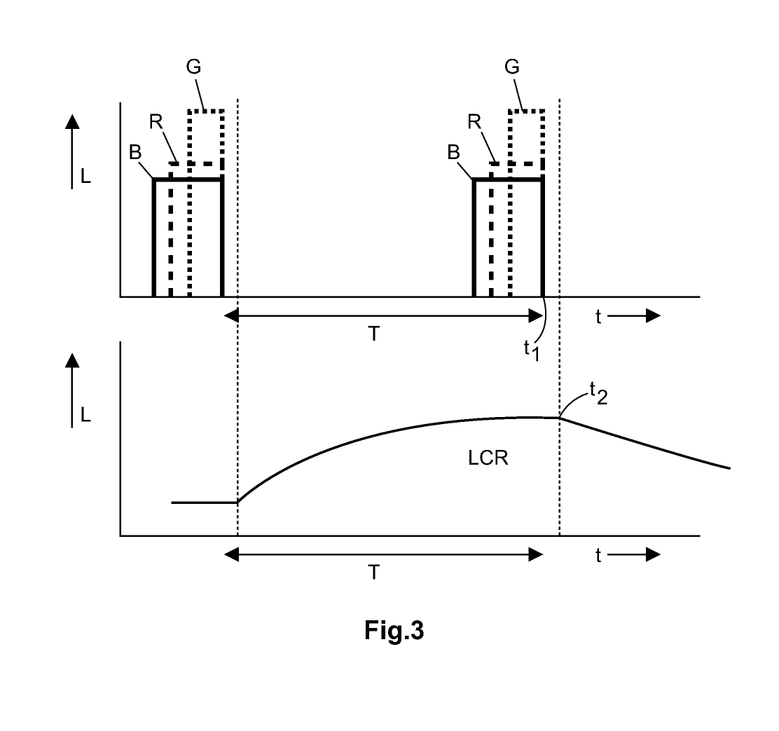

FIG. 3 shows a diagram for illustrating the light output of the R, G and B sub-pixel for a single pulse scanning backlight. In the upper diagram, the relationship of the light output L with respect to time t is depicted for green G, red R and blue B sub-pixels. The time period of the single pulse scanning is T. In the lower diagram, the response LCR of the liquid crystal cells depicted over time corresponding to the scanning of red, green and blue pixels in the upper diagram is shown. In particular, the light output L of the R, G and B sub-pixels are depicted with an individual duty cycle for each of the sub-pixels. The particular duty cycle ratio of the R, G and B sub-pixels are determined by means of the above-mentioned white-point setting. Therefore, the green G sub-pixel has the shortest duty cycle while the blue B sub-pixel has the longest duty cycle. Preferably, the pulses of the red R, green G and blue B sub-pixels are aligned such that the light output L of all three sub-pixels is active at t₁ just before the liquid crystal cells are addressed for an upcoming frame of the video data t₂, i.e. the red R, green G and blue B sub-pixels are aligned to the moment when the liquid crystal material is optimally settled (t₁). In other words, the single pulse scanning backlight is optimized to provide an optimal exposure of the LCD panel at that point of time t₁ when the liquid crystal material has settled. On the other hand, such a driving scheme may be disadvantageous for moving objects as they may comprise different motion blurs on various edges of an object. In particular, dark-to-bright edges will be very sharp while bright-to-dark edges may have some kind of colored blur.

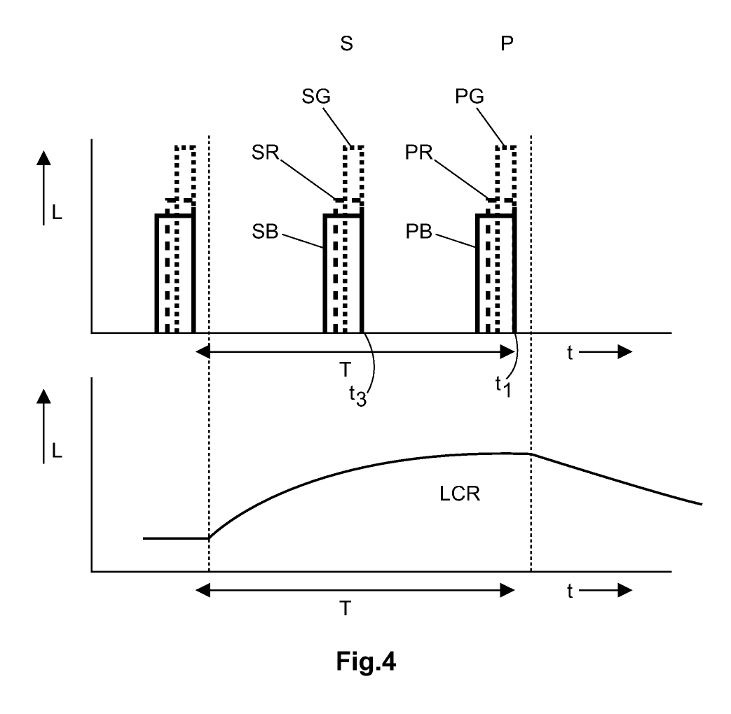

FIG. 4 shows a diagram of the light output L of red R, green G and blue B sub-pixels for double-pulse scanning backlight according to a second embodiment. Instead of merely one scanning pulse as described according to FIG. 3, the double-pulse scanning backlight according to FIG. 4 has a primary and a secondary pulse P, S at t₁ and t₃ within one time period T, respectively. Accordingly, the primary pulse P will comprise a primary green pulse PG, a primary red pulse PR and a primary blue pulse PB while the secondary pulse S will comprise a secondary green pulse SG, a secondary red pulse SR and a secondary blue pulse SB. Preferably, the primary pulses PG, PR and PB are aligned at t₁, i.e. immediately before the liquid crystal cells of the LCD panel are addressed by the next frame of the video data corresponding to that moment when the liquid crystal cells are optimally settled. On the other hand, the secondary pulse SG, SR, SB are aligned in the middle of two subsequent primary pulses P, i.e. at t₃ suppressing any occurring flicker.

With the double-pulse scanning backlight according to the second embodiment, an optimal exposure of the LCD panel is achieved, for the case that the liquid crystal material has settled. However, as mentioned above, moving objects may comprise different motions of blur on various edges of the objects.

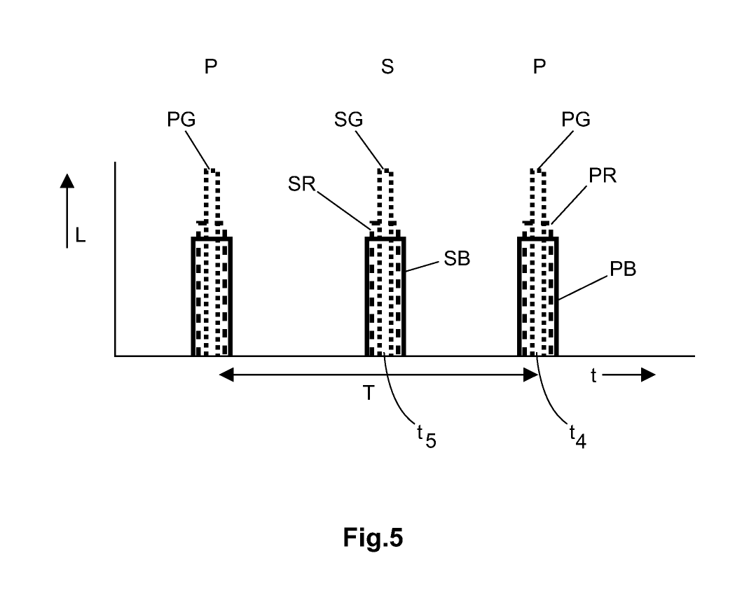

FIG. 5 shows a diagram of a double-pulse scanning backlight according to a third embodiment. Here, the red R, green G and blue B pulses of the primary and secondary pulse P, S of the double-pulse scanning are aligned at the centers of the respective pulses, i.e. at t₄, t₅, respectively. Hence, by such an alignment, the blurring on various edges of objects is now symmetrical.

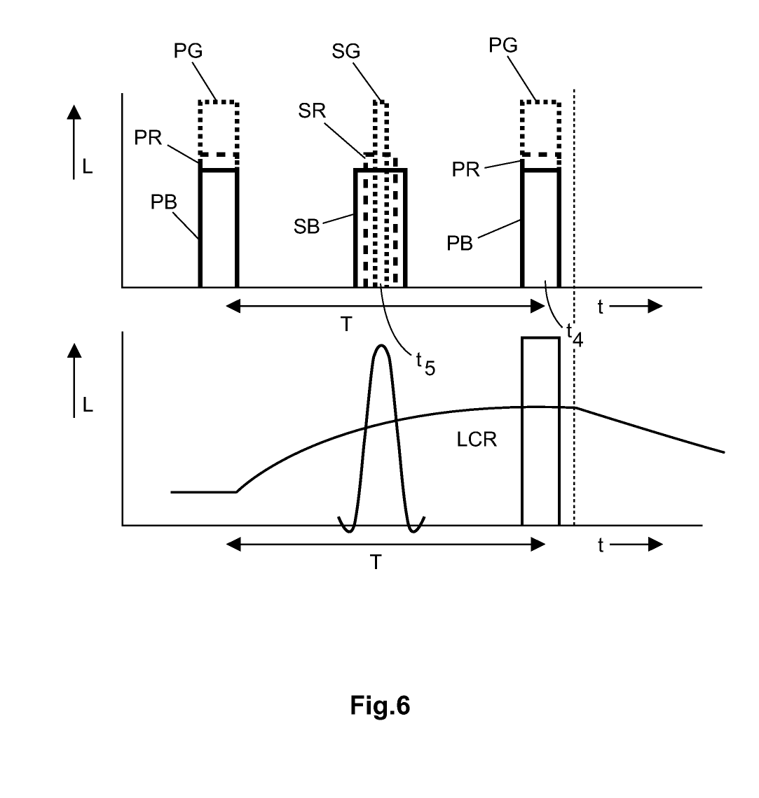

FIG. 6 shows a diagram to illustrate the primary and secondary pulses of a double-pulse scanning backlight according to a fourth embodiment. Here, the duty cycles of the red R, blue B and green G sub-pixels correspond to each other to enable a bright and sharp exposure of the primary pulse wherein the centers of the duty cycles are aligned at t₄. The duty cycles of the red R, green G and blue B sub-pixels are different for the secondary pulse and the centers of the red R, green G and blue B pulses are aligned at t₅ as described according to the third embodiment. By providing different duty cycles for the secondary sub-pixels SG, SR and SB as well as by aligning the centers of the secondary sub-pixels, i.e. at t₅, a blurred exposure can be achieved by the secondary pulse. As the colored blur is achieved by the secondary pulse, it is now located in a position with a minimal impact on the picture performance due to the fact that a tracking eye will lock onto a sharp exposes image.

Hence, according to the fourth embodiment, the first primary pulse P is a bright and sharp pulse with equal or corresponding duty cycles while the secondary pulse S comprises different duty cycles, and while the centers of the secondary pulses are aligned (e.g. at t₄). The double-pulse scanning according to the fourth embodiment will therefore not add any additional cost to the LCD device as no special or additional switching is required.

The primary pulses PR, PG, PB of the red R, green G and blue B LEDs may be driven at their maximum luminance but with the same phase and the same identical duty cycle centered at e.g. t₄. Therefore, the luminance of the primary pulse may induce image flicker at the nominal frame rate. This image flicker can be compensated by the luminance of the secondary pulses. Here, the differences in the color of the two pulses is not important as spectrum sequential displays also run at this field-rate. Preferably, the duty cycle of the primary pulse P is chosen such that the base-band component of the luminance corresponds to sum of the base-band components of the red R, green G and blue B luminance of the secondary pulse such that no visible image flicker is present at the front of screen performance.

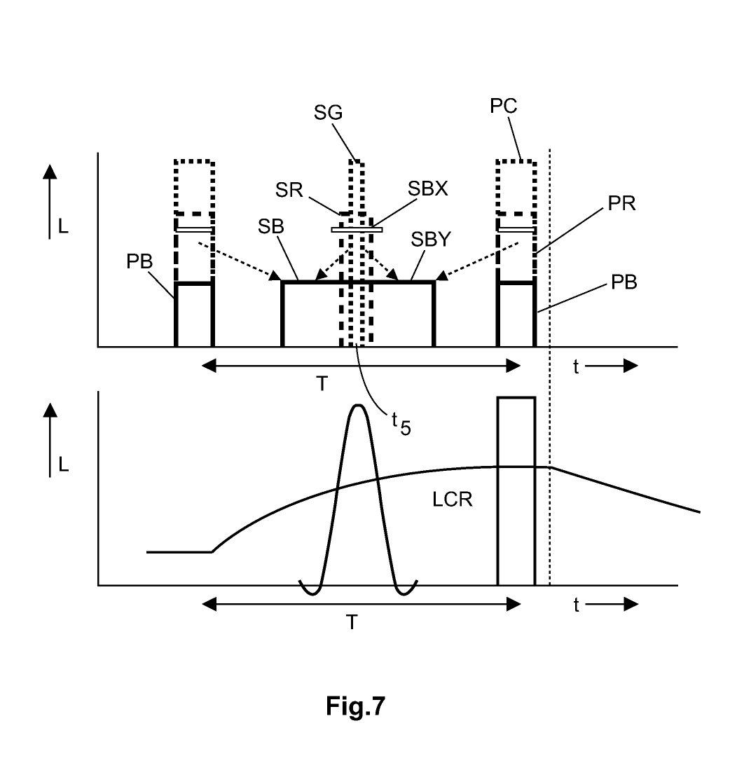

FIG. 7 shows a diagram of the double-pulse scanning backlighting according to a fifth embodiment. According to the fifth embodiment, the light capacity of the blue LEDs is reduced by for example 50%, i.e. the cost of blue LEDs is reduced by 50%. The primary and secondary pulses of the green and red according to the fifth embodiment correspond to the primary and secondary pulses of green and red according to the fourth embodiment. If the light capacitance of the blue LEDs is reduced from the level SBX to the level SBY, then the duty cycle of the secondary blue pulse SB has to be increased. According to the fifth embodiment, the primary pulse PG, PR, PB ensures a bright and sharp exposure even though the primary blue pulse PB is reduced such that the primary pulse has merely 95% of its initial luminance. The duty cycles correspond to each other. The secondary pulse ensures the blurred exposure with an additional 5% luminance increase. Accordingly, the color modulation between the pulses is increased. Furthermore, the blue color has some additional blur which is located at a position t₅ with a minimal impact on the picture performance. The difference of the additional blur in the blue color is hardly noticeable for a human eye as the human eye is less sensitive to the spatial and temporal resolution of the blue color.

As with the fourth embodiment, the double-pulse scanning backlight according to the fifth embodiment does not need any special switching such that no additional cost is introduced.

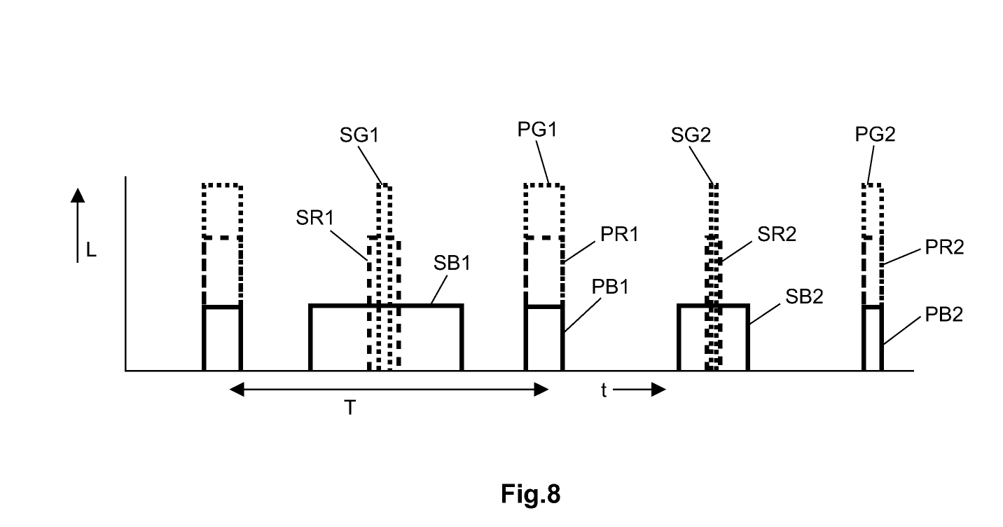

FIG. 8 shows a diagram of a double-pulse scanning according to a sixth embodiment. The diagram according to the sixth embodiment substantially corresponds to the diagram according to the fifth embodiment with respect to the nominal double-pulses SG1, SR1, SB1; PG1, PR1 and PB1. If an additional dimming of the backlight is required, the duty cycles of the sub-pixels can be modulated to reduce the produced amount of light, which results in a reduced black-level and in the creating of a larger contrast-ratio while reducing the power consumption.

The above described liquid crystal display device can be used in a LCD-TV or in any other multi-media displays which comprise a scanning backlight with different color components.

According to the invention, the duty-cycles of the colored LED segments of a scanning LCD backlight is controlled in order to improve an optimal motion portrayal without perceptive flicker. A stratoscopic exposure of moving images on the LCD panel can be achieved by the scanning backlight thus improving the motion portrayal. Preferably, a double pulse scanning is used, wherein the primary light pulse is adapted to give a sharp and bright exposure while the secondary pulse is used to give a smooth exposure to create a blurred secondary image on the LCD panel. By driving colored blur symmetrically to both edges, a motion portrayal can be enhanced. By shifting all colored blur to the secondary pulse, the motion portrayal can be further enhanced. As a longer duty cycle for the blue and possibly the red color is selected, the costs can be reduced as well.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. In the device claim enumerating several means, several of these means can be embodied by one and the same item of hardware. The mere fact that certain measures are recited in mutually different dependent claims does not indicate that a combination of these measures cannot be used to advantage.

Furthermore, any reference signs in the claims shall not be constrained as limiting the scope of the claims.

1. Liquid crystal display device, comprising:
a liquid crystal display panel (LCDP) for displaying an image or a video signal;
a double-pulse scanning backlight means having a plurality of red, green and blue colored light emitting diodes arranged in rows for backlighting the liquid crystal display panel on a double-pulse scanning basis; and
double-pulse scanning control means for controlling the time sequential double-pulse scanning of the plurality of colored light emitting diodes of the back light means and for driving the time sequential double-pulse scanning of the plurality of colored light emitting diodes.

2. Display device according to claim 1, wherein:
the control means is adapted to drive the plurality of colored light emitting diodes with a primary and a secondary pulse within a scanning time period,
wherein duty cycles for the red, green and blue light emitting diodes correspond to each other for the primary pulse,
wherein duty cycles for the red, green and blue light emitting diodes can be different from each other for the secondary pulse.

3. Display device according to claim 1, wherein:
the duty cycles of the light emitting diodes for the secondary pulse have a common center.

4. Display device according to claim 1, wherein:
the duty cycles of the blue light emitting diode during the secondary pulse are longer than the duty cycles for the red or green light emitting diodes during the secondary pulse,
wherein the light capacity of the blue light emitting diodes is smaller than the light capacity of the red or green light emitting diodes.

5. Display device according to claim 1, wherein:
the control means is adapted to dim the light output of the backlight means by reducing the duty cycles of the colored light emitting diodes during the primary and secondary pulse.

6. Method for driving a liquid crystal display device having a liquid crystal display panel for displaying an image or a video signal and a double-pulse scanning backlight means with a plurality of red, green and blue colored light emitting diodes arranged in rows for backlighting the liquid crystal display panel, comprising:
controlling the time sequential double-pulse scanning of the plurality of colored light emitting diodes of the backlight means, and
driving the time sequential double-pulse scanning of the plurality of colored light emitting diodes.
